(19) United States
(12) Patent Application Publication
(10) Pub. No.: US 2002/0010020 A1
(43) Pub. Date: Jan. 24, 2002

(54) Friction enhancing accessories for game controllers

(76) Inventor: Glen Johnson, Seattle, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 09/840,793

(22) Filed: Apr. 25, 2001

Related U.S. Application Data
(60) Provisional application No. 60/199,798, filed on Apr. 26, 2000.

(51) Int. Cl. A63F 13/02

(52) U.S. Cl. 463/37; 463/47

(57) ABSTRACT

One or more friction enhancing elements for use with game controllers to reduce slippage of a user's hand and digits when operating the controller over a period of time. The invention includes a flexible sheet of material wherein at least an upper surface thereof has friction enhancing properties and a lower surface thereof has adhesive properties. A release sheet is removably associated with the lower surface of the flexible sheet, thereby preserving the adhesive nature of the lower surface until removed by a user. The flexible sheet preferably has one or more geometric forms substantially corresponding to active elements or input portions of the game controller, although the sheet may consist of only a single geometric form. Alternatively or in addition, the one or more geometric forms may correspond to a non-active gripping portion of the controller. Enhancements include surface or integral incorporation of particulates to increase friction or hydrophilic constituents to decrease the effect of user perspiration.

### TECHNICAL FIELD:

The present invention relates to accessories for use with electronic input devices, and more particularly to grip enhancing pads for use with video game console controllers.

### BACKGROUND OF THE INVENTION:

The genesis of consumer grade video games can be found with the introduction of PONG during the 1970s. The input device for this game consisted merely of a large console having a pair of rotatable knobs and several buttons. The level of user interaction with the game then was relatively limited given the simplicity of the games and modes of interaction. Further developments in video game technology yielded the Atari 2600 console, which relied upon a joystick input device. The joystick consisted of a controller having a single button and a multi-directional joystick.

Not until the introduction of the Nintendo Entertainment System did controllers include numerous buttons and/or joysticks in a single controller. Furthermore, the games created for the Nintendo Entertainment System required particularly quick reflexes and rapid user manipulation of the controller. Given the intense nature of play and the fact that many games required minutes if not hours of interaction, a natural consequence to the user was sweaty palms.

To facilitate rapid manufacturing of and decreased costs for present game controllers, such controllers are usually constructed from thermoplastics using an injection molding process. While the resulting controller is durable and resistant to damage, the coefficient of friction between the user's palms and digits, and the controller after long periods of play becomes quite low, due in large part to perspiration forming between the user and the controller.

A possible solution to this problem is to alter the manufacturing process of the controller to include the integration of materials having a higher coefficient of friction and/or absorptive properties. This solution, however, does not address the problems with existing controllers. Therefore, a need exists to retrofit existing game controllers to include friction enhancing surfaces so as to reduce the propensity of a users fingers or palms from slipping on the outer surfaces of the game controller, thus reducing the gaming experience.

### SUMMARY OF THE INVENTION

The present invention is intended to provide a user of an existing game controller with means for modifying the controller to enhance the coefficient of friction between the user's hand and the game controller during a gaming session. The invention comprises a flexible sheet of material wherein at least an upper surface thereof has friction enhancing properties and a lower surface thereof has adhesive properties. A release sheet is removably associated with the lower surface of the flexible sheet, thereby preserving the adhesive nature of the lower surface until removed by a user. The flexible sheet preferably has one or more geometric forms substantially corresponding to active elements or input portions of the game controller, although the sheet may consist of only a single geometric form. Alternatively, the one or more geometric forms may correspond to a non-active gripping portion of the controller so as to prevent unintentional slippage of the controller when gripped by a user.

The previously mentioned selected portions of the game controller generally correspond to input elements thereof. For example, input buttons, joysticks, and switches are considered input elements of the game controller. By removing the one or more geometric shapes from the release sheet, and applying the one or more geometric shapes to the active elements of the game controller, a user can increase the coefficient of friction between the user's hand and the active elements, thereby increasing the level of user satisfaction when engaging in gaming activities.

In addition to the friction enhancing properties of the flexible sheet of material previously described, the material may be resilient and/or hydrophilic. By including these properties in the flexible sheet of material, an enhanced feel for the controller can be obtained, and/or perspiration emanating from a user's hand can be partially absorbed by the material, thereby decreasing the presence of a low friction boundary between the material and the user's hand.

The invention also preferably includes geometric shapes not limited to those corresponding to active elements of the game controller. For example, portions of the game controller intended to be gripped by the user may also subject to slippage, and therefor will benefit from application of a friction enhancing material.

The friction enhancing material of the present invention preferably comprises a flexible plastic substrate which is impregnated with a silica grit or other abrasive and/or particulate material. An adhesive layer is provided on the side of the substrate opposite the impregnated side. A release sheet is removably adhered to the adhesive to protect the same. A commercially available embodiment is Minnesota Mining and Manufacturing's (3M's) Safety Walk™ Tread. This product comes in non-resilient, minimally resilient and medium resilient forms.

The flexible sheet of material is preferably manufactured by determining the geometric forms necessary for a particular game controller, and die cutting the desired geometric forms into the sheet of material. The process may use a single sheet into which a plurality of forms are created; it may use a single sheet into which a plurality of forms are created and the surrounding material removed so that only discrete forms remain; it may use a single sheet in which only a single form is created. Therefore, given the diversity of manufacturing objectives, the method for creating the forms is not limited to any particular type of process, but instead concerns the ability to recognize portions of the game controller that would benefit from increased friction, and mapping those portions onto a flexible sheet of resilient material, creating a form based upon the mapped information, and presenting the form for use by a gamer.

### BRIEF DESCRIPTION OF THE DRAWINGS

FIG. 1 is a perspective view of a game controller and details the placement of the friction enhancing forms at selected portions thereon;

FIG. 2 is a perspective view of a flexible sheet of resilient material wherein a plurality of geometric forms have been die cut therein, generally corresponding to selected portion of the controller shown in FIG. 1; and

FIG. 3 is a cross-section elevation view taken substantially along the lines 3--3 in FIG. 1 detailing the composition of a preferred embodiment of the invention.

### DETAILED DESCRIPTION OF THE INVENTION

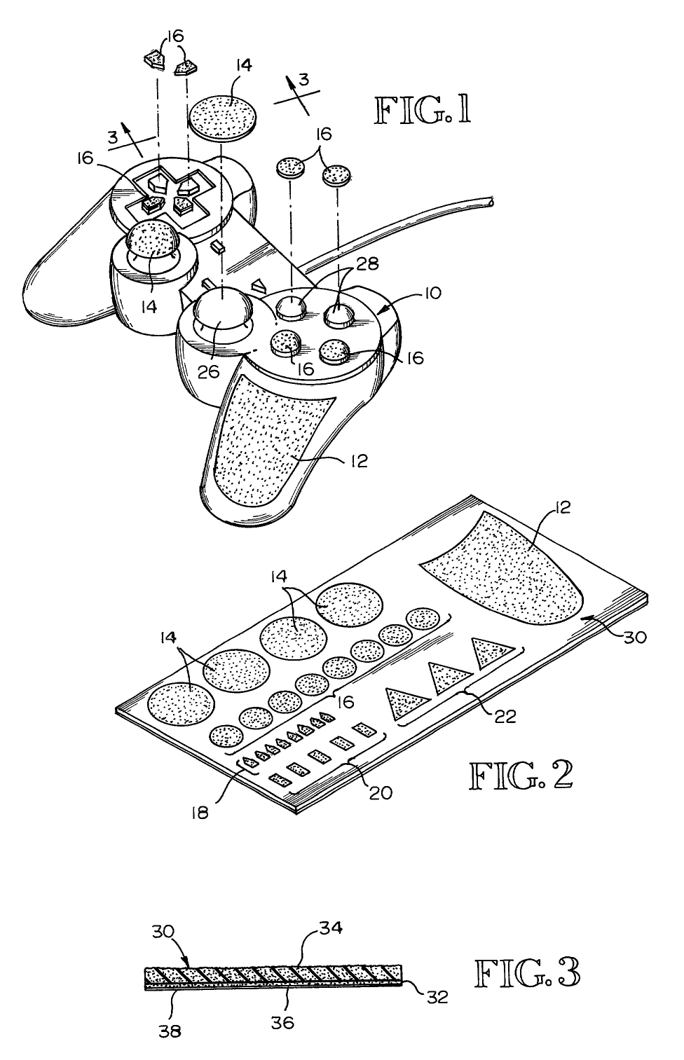

Turning then to the several figures wherein like numbers indicate like parts, and more particularly to FIG. 1, a game controller 10 is shown in a state wherein several friction enhancing forms are present thereon. The various geometric forms applied to controller 10 are obtained from sheet 30, shown in FIG. 2. Included in sheet 30, are circular forms 14 and 16, pentagons 18, rectangles 20, triangles 22, and form 12. The nature of the geometric forms is roughly obtained by determining the planar equivalent of the active elements present in controller 10. Thus, for example, while joystick 26 and buttons 28 can be generally characterized as domes or domed cylinders, a plan view thereof will yield a circular profile. Consequently, circular forms 14 and 16 correspond to the planar equivalent of these active elements. Because sheet 30 may have resilient properties, it is not necessary to create geometric forms that are three-dimensional, unless the active elements of the game controller have a significant cross-sectional elevation profile. Since this is rarely the case, the aforementioned approximation is sufficient for meeting the objectives of the invention.

Also shown in FIGS. 1 and 2 is form 12. Form 12 is similarly created based upon the planar equivalent of a selected non-active portion of controller 10. As illustrated in FIG. 1, the location of form 12 roughly corresponds to the position occupied by a user's palm during engagement with controller 10. By including this friction enhancing element, incidental an unintentional movement of controller 10 is generally eliminated.

Turning to FIG. 3, it can be seen that sheet 30 has an upper portion 34 and a lower portion 36. Applied to lower portion 36 is adhesive layer 32. The also present at lower portion 36 release sheet 38. Release sheet 38 protects the fidelity of adhesive layer 32 until the element is ready to be placed on controller 10 by the user.

In a preferred form, a quantity of sheets 30 are manufactured from a roll stock of material as described above, and the desired geometric forms created therein by a rotary die cutting process. Those person skilled of the art will appreciate alternative methods for creating the desired forms in the sheet of material, including rule cutting, laser cutting, waterjet cutting, and others. As described previously, the geometric forms may occupy a single discrete sheet, or may be “punched”0 from a master stock whereby the user would have a collection of forms, each having an adhesive layer and a backing sheet, but all being separate from one another.

What is claimed:

1. A friction enhancing gaming controller accessory comprising:
a flexible sheet of material defining at least one geometric form substantially corresponding to at least one portion of the gaming controller, the material comprising an upper surface having friction enhancing properties and a lower surface having adhesive properties; and
a release sheet removably attached to the lower surface of the flexible sheet.

2. The accessory of claim 1 wherein the friction enhancing properties result from the incorporation of particulate matter securely applied to the upper surface of the flexible sheet.

3. The accessory of claim 1 wherein the friction enhancing properties result from the incorporation of particulate matter integrated into the upper surface of the flexible sheet.

4. The accessory of claim 1 wherein the friction enhancing properties result from the incorporation of a hydrophilic component securely applied to the upper surface of the flexible sheet.

5. The accessory of claim 1 wherein the friction enhancing properties result from the incorporation of a hydrophilic component integrated into the upper surface of the flexible sheet.

6. The accessory of claim 1 wherein the flexible sheet has resilient properties.

7. The accessory of claim 1 wherein the sheet defines a plurality of geometric forms substantially corresponding to a plurality of select portions of the gaming controller.

8. The accessory of claim 1 wherein the at least one geometric form corresponds to an input element of the gaming controller.

9. The accessory of claim 1 wherein the at least one geometric form corresponds to a non-input portion of the gaming controller.

10. The accessory of claim 1 wherein the friction enhancing properties result from the incorporation of a material selected from the group consisting of particulate matter securely applied to the upper surface of the flexible sheet, a particulate matter integrated into the upper surface of the flexible sheet, a hydrophilic component securely applied to the upper surface of the flexible sheet, and a hydrophilic component integrated into the upper surface of the flexible sheet, and wherein the sheet defines a plurality of geometric forms.

11. A method for creating a friction enhancing gaming controller accessory comprising:
identifying one or more portions of a gaming controller wherein enhanced friction properties are desired;
identifying the geometric boundaries of the one or more portions for which enhanced friction properties are desired;
forming one or more friction enhancing elements from a sheet of flexible material having an upper surface including friction enhancing properties and a lower surface having adhesive properties using the identified geometric boundaries.

12. The method of claim 11 wherein the friction enhancing properties result from the incorporation of particulate matter securely applied to the upper surface of the flexible sheet.

13. The method of claim 11 wherein the friction enhancing properties result from the incorporation of particulate matter integrated into the upper surface of the flexible sheet.

14. The method of claim 11 wherein the friction enhancing properties result from the incorporation of a hydrophilic component securely applied to the upper surface of the flexible sheet.

15. The method of claim 11 wherein the friction enhancing properties result from the incorporation of a hydrophilic component integrated into the upper surface of the flexible sheet.

16. The method of claim 11 wherein the flexible sheet has resilient properties.

17. The method of claim 11 wherein the sheet defines a plurality of geometric forms substantially corresponding to a plurality of select portions of the gaming controller.

18. The method of claim 11 wherein the at least one geometric form corresponds to an input element of the gaming controller.

19. The method of claim 11 wherein the at least one geometric form corresponds to a non-input portion of the gaming controller.

20. The method of claim 11 wherein the friction enhancing properties result from the incorporation of a material selected from the group consisting of particulate matter securely applied to the upper surface of the flexible sheet, a particulate matter integrated into the upper surface of the flexible sheet, a hydrophilic component securely applied to the upper surface of the flexible sheet and a hydrophilic component integrated into the upper surface of the flexible sheet, and wherein the sheet defines a plurality of geometric forms.

21. A method for enhancing the coefficient of friction of a gaming controller comprising:
identifying a portion of the gaming controller wherein enhanced friction properties are desired;
selecting a geometric form from a plurality of geometric forms wherein the geometric form comprises a flexible sheet of material having an upper surface including friction enhancing properties and a lower surface having adhesive properties, and a release sheet removably attached to the lower surface of the flexible sheet;
removing the release sheet from the selected geometric form; and
applying the selected geometric form to the identified portion of the gaming controller.
